(19) United States
(12) Patent Application Publication
(10) Pub. No.: US 2020/0293641 A1
(43) Pub. Date: Sep. 17, 2020

(54) USING PALMAR FEATURES WITH A FINGERTIP AGGREGRATE FOR BIOMETRIC ANALYSIS TO CONSERVE RESOURCES

(71) Applicant: HECTOR HOYOS, RIDGEFIELD, CT (US)

(72) Inventor: HECTOR HOYOS, RIDGEFIELD, CT (US)

(21) Appl. No.: 16/355,830

(22) Filed: Mar. 17, 2019

(51) Int. Cl. G06F 21/32; G06K 9/00

(52) U.S. Cl. CPC G06F 21/32; G06K 9/00013; G06K 9/00093

(57) ABSTRACT

A method for authenticating hand biometrics that begins with a biometric security system receiving a palm-up digital image of a user's hand. The palm section and a fingertip aggregate section can be identified. The palm section can be processed and compared to reference palm sections. A first verification score for each reference palm section can be generated. When the first verification score fails to meet a first threshold, the biometric authentication process can be terminated. When one or more reference palm sections meet the first threshold, the fingertip aggregate can be processed and compared to reference fingertip aggregate sections respective to the palm sections. A second verification score can then be generated for each reference. This generation can be performed on fewer reference fingertip aggregate sections, decreasing overall resource consumption. When the second verification score meets a second threshold, the biometric authentication can be successful.

### BACKGROUND

The present invention relates to the field of biometric security, and more particularly to using palmar features with a fingertip aggregate for biometric analysis to conserve resources.

Biometric-based security measures (e.g., retinal scans, fingerprint authentication, voice recognition, etc.) have long been considered to be the epitome of protection. These measures are often used for physical access control, as they often require sensitive and/or specialized hardware devices. Advancements in electronics and other related user device technologies are producing more powerful user devices that are capable of capturing a user's biometric data, allowing for remote data capture.

For example, many commercial laptop computers include facial recognition software that is usable for controlling access to the laptop instead of the typical username and password. Similarly, various commercial smartphones and laptop computers are capable of using a user's fingerprint for identity verification.

However, the problem still remains that digital fingerprint verification consumes a significant amount of time and resources, especially when the fingerprint data needs to be compared to a large library of references. Approaches have been proposed to reduce resource consumption by reducing the quantity and/or quality of the fingerprint data used while trying to maintain an acceptable level of accuracy. These approaches still search the entire library, so the resource savings is minimal.

Therefore, what is needed is an approach that reduces the quantity of records that fingerprint verification is performed upon while maintaining a high level of accuracy. Such an approach would use an image of the user's entire hand, using palmar features (e.g., minutiae, size, shape, creases, etc.) to filter the library to a smaller subset of records that will most likely produce a match in fingerprint analysis.

### BRIEF SUMMARY

One aspect of the present invention can include a method for authenticating hand biometrics that begins with a biometric security system receiving a digital image of a user's hand. The hand can be presented palm-up and can include a full-length view of four fingers excluding the thumb. Within the received image, a palm section of the hand and a fingertip aggregate section can be identified. The fingertip aggregate section can be comprised of contiguous fingertip areas of each finger. Then, the identified palm section can be prepared for comparison to one or more reference palm sections maintained by the biometric security system. The reference palm section can be established during user registration with the biometric security system. A first verification score for each reference palm section can be generated. The first verification score can quantify a likeness between the prepared palm section and a reference palm section. When the first verification score fails to meet a first predetermined verification threshold, the biometric authentication process can be terminated. Indication of the failed authentication can be provided to the user and a computer system that the biometric security system safeguards, conserving the resources required to process the user's fingertip aggregate section. When one or more reference palm sections meet the first predetermined verification threshold, the identified fingertip aggregate section can be prepared for comparison to reference fingertip aggregate sections respective to the one or more palm sections. The respective reference fingertip aggregate sections can be established during user registration with the biometric security system. A second verification score can then be generated for each reference fingertip aggregate section. The second verification score can quantify a likeness between the prepared fingertip aggregate section and a reference fingertip aggregate section. This generation can be performed on a quantity of reference fingertip aggregate sections equal to or less than a total number of reference fingertip aggregate sections maintained by the biometric security system. The overall amount of resources spent processing reference fingertip aggregate sections can be decreased by at least twenty percent as compared to the amount of resources spent processing all reference fingertip aggregate sections. When the second verification score meets a second predetermined verification threshold, a successful biometric authentication can be indicated to the user and a computer system that the biometric security system safeguards.

Another aspect of the present invention can include a method for device-based processing of hand biometrics that begins with the receipt of user-selection of an operation for execution by a biometric security service that is running on a resource-constrained end-user device. The selected operation can require successful biometric authentication of the user to be executed. A threshold value for the user-selected operation can be dynamically ascertained. The threshold value can indicate a stringency of the biometric authentication for the user-selected operation. The threshold value can be calculated based upon a set of current operating parameters and a privilege level of the user and/or selected from a predefined list of values associated with available operations. A digital image of the user's hand can then be received for the biometric authentication. The hand can be presented palm-up and include a full-length view of four fingers excluding the thumb. Within the received image, a palm section of the hand and a fingertip aggregate section can be identified. The fingertip aggregate section can comprise contiguous fingertip areas of each finger. The identified palm section can be prepared for comparison to a reference palm section for the user. The reference palm section can be established during user registration with the biometric security service. A first verification score for the reference palm section can be generated. The first verification score can quantify a likeness between the prepared palm section and the reference palm section. When the first verification score fails to meet a first predetermined verification threshold, biometric authentication can be terminated. Indication of the failed authentication can be provided to the user and execution of the user-selected operation can be prohibited. It can be assumed that a successful authentication of the fingertip aggregate section after the failure of the palm section is untrustworthy. Therefore, the end-user device resources required to process the fingertip aggregate section can be conserved by terminating the authentication process. When the reference palm section meets the first predetermined verification threshold, the identified fingertip aggregate section can be prepared for comparison to a reference fingertip aggregate section. The reference fingertip aggregate section can be established during user registration with the biometric security service. A second verification score for the reference fingertip aggregate section can be generated. The second verification score can quantify a likeness between the prepared fingertip aggregate section and the reference fingertip aggregate section. When the second verification score meets a second predetermined verification threshold, a successful biometric authentication can be indicated to the user and the user-selected operation can be allowed to execute.

Yet another aspect of the present invention can include a computer program product that includes a computer readable storage medium having embedded computer usable program code. The computer usable program code can be configured to receive a digital image of a hand belonging to a user. The hand can be presented palm-up and include a full-length view of four fingers excluding the thumb. The computer usable program code can be configured to identify, within the received image, a palm section of the hand and a fingertip aggregate section. The fingertip aggregate section can comprise contiguous fingertip areas of each finger. The computer usable program code can be configured to prepare the identified palm section for comparison to a reference palm section. The reference palm section can be established during user registration. The computer usable program code can be configured to generate a first verification score for each reference palm section. The first verification score can quantify a likeness between the prepared palm section and a reference palm section. The computer usable program code can be configured to, when the first verification score fails to meet a first predetermined verification threshold, terminate the biometric authentication process. Indication of the failed authentication can be provided to the user and a computing system. The resources required to process the user's fingertip aggregate section can be conserved. The computer usable program code can be configured to, when at least one reference palm section meets the first predetermined verification threshold, prepare the identified fingertip aggregate section for comparison to at least one reference fingertip aggregate section respective to the at least one palm section. The at least one respective reference fingertip aggregate section can be established during user registration. The computer usable program code can be configured to generate a second verification score for each reference fingertip aggregate section. The second verification score can quantify a likeness between the prepared fingertip aggregate section and a reference fingertip aggregate section. This generation can be performed on a quantity of reference fingertip aggregate sections equal to or less than a total number of reference fingertip aggregate sections. The overall amount of resources spent processing reference fingertip aggregate sections can be decreased by at least twenty percent as compared to an amount of resources spent processing all reference fingertip aggregate sections. The computer usable program code configured to, when the second verification score meets a second predetermined verification threshold, indicate a successful biometric authentication to the user and computing system.

### BRIEF DESCRIPTION OF THE SEVERAL VIEWS OF THE DRAWINGS

FIG. 1 is a flowchart of a method describing the general use of the improved hand-based biometric security service in accordance with embodiments of the inventive arrangements disclosed herein.

FIG. 2 is a schematic diagram of a system that utilizes palmar characteristics as a filter when performing hand-based biometric authentication in accordance with embodiments of the inventive arrangements disclosed herein.

FIG. 3 is a flowchart of a method detailing the use of palmar data as a filter for a biometric reference library in accordance with embodiments of the inventive arrangements disclosed herein.

FIG. 4 is a collection of illustrations that graphically depict an example use of palmar and fingertip biometrics for biometric authentication in accordance with embodiments of the inventive arrangements disclosed herein.

### DETAILED DESCRIPTION

Embodiments of the disclosed invention can present a solution for conserving resources involved in the digital fingerprint identification process by utilizing palmar features as a filter. A user's hand image can be captured for processing by the biometric security system. The biometric security system can process the palm section of the user's hand image first. The processed palm section can then be compared to a biometrics library, each library record having a reference standard for a palm section and a fingertip aggregate section. This comparison can generate a verification score for each record that is evaluated against a predetermined verification threshold. Those records meeting the verification threshold can proceed for fingertip analysis. Since fingertip analysis is resource-intensive, a smaller pool of records to process can save the biometric security system time and computing resources, as well as allow for flexibility in the biometric authentication process.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

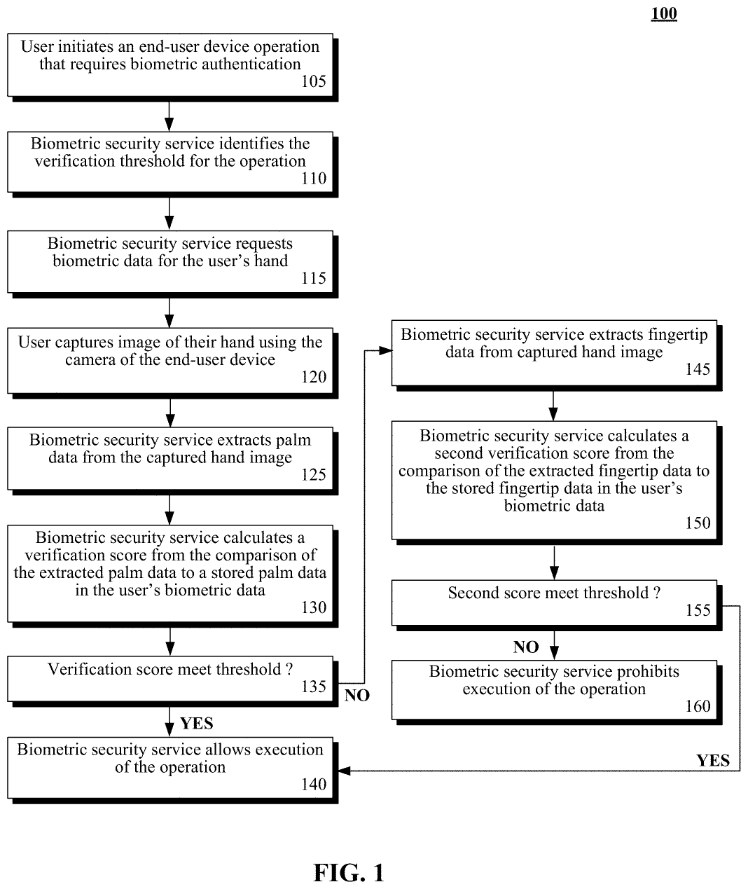

FIG. 1 is a flowchart of a method 100 describing the general use of the improved hand-based biometric security service in accordance with embodiments of the inventive arrangements disclosed herein. Method 100 can begin with step 105 where the user initiates an operation on their end-user device that requires biometric authentication.

The end-user device can be configured to utilize a secure computer architecture that implements biometric security for operations that handle sensitive data or functions like accessing device management functions. A HOYOS BIB LOS (Biometrics BLOckchain Secure) device running the INTEGRITY secure real-time operating system (RTOS) can be an example of such a device, as taught in <HVSN2017001US1>.

Step 105 can be expanded to include other triggers for user biometric authentication like interacting with the HOYOS Real-time Integrity Secure Environment or RISEN, as taught in <HVSN2018012US1>, or per the settings of a software application.

The biometric security service running on the end-user device can identify the verification threshold for the operation in step 110. The verification threshold can represent a minimum value that the biometric authentication must meet to be successful. In essence, the verification threshold can express the amount of variance or noise that is acceptable in the authentication to perform the user-selected operation. A highly-secure operation can have a higher verification threshold (less variance); a minimally-secure operation can have a lower verification threshold (more variance).

The manner in which step 110 is performed can be dependent upon the specific implementation. In one embodiment, the biometric security service can use a lookup table or a list that correlates operations with verification threshold values. In another embodiment, the biometric security service can be configured to dynamically calculate the verification threshold using a preset formula and accessible data like the user's role or security privileges, selected operation, available resources, and so on.

In step 115, the biometric security service can request biometric data for the user's hand. The user can capture an image of their hand using the camera of the end-user device in step 120. In the image, the user's hand can be facing palm-up (towards the camera) with all four fingers (not the thumb) included.

In step 125, the biometric security service can extract palm data from the captured hand image. The biometric security service can then calculate a verification score from the comparison of the extracted palm data to the stored palm data in the user's biometric data, in step 130. The user can have been required to establish baseline biometric data when registering with the biometric security service.

In step 135, it can be determined if the calculated verification score meets the verification threshold for the user-selected operation. When the verification score meets the verification threshold, the biometric security service can allow the user-selected operation to execute on the end-user device in step 140. Performance of step 140 can indicate that the user has had their identity successfully biometrically authenticated.

When the verification score does not meet the verification threshold, step 145 can be performed where the biometric security service extracts fingertip data from the captured hand image. The biometric security service can calculate a second verification score from the comparison of the extracted fingertip data to the stored fingertip data in the user's biometric data, in step 150.

In step 155, it can be determined if the second verification score meets the verification threshold. When the second verification score meets the verification threshold, step 140 can be performed. When the second verification score does not meet the verification threshold, the biometric security service can prohibit execution of the user-selected operation on the end-user device in step 160. Performance of step 160 can indicate that the user has unsuccessfully biometrically authenticated their identity.

In another contemplated embodiment, the verification score calculated for the palm data can be combined with the verification score calculated for the fingertip data, and that composite verification score can be substituted for the second score in step 155.

In yet another embodiment, different verification thresholds can be used for the palm data and the fingertip data. This can require both values to be retrieved in step 110.

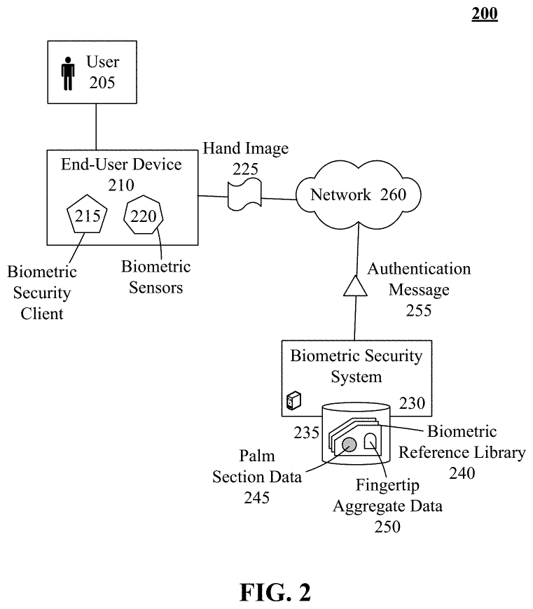

FIG. 2 is a schematic diagram of a system 200 that utilizes palmar characteristics as a filter when performing hand-based biometric authentication in accordance with embodiments of the inventive arrangements disclosed herein. System 200 can be used to perform the steps of method 100.

In system 200, the user 205 can use the biometric sensors 220 and biometric security client 215 on their end-user device 210 to have an associated biometric security system 230 authenticate their hand image 225 to access a secured element, including, but not limited to a location, a computer system, a software application or service, their end-user device 210, an operation associated with the computer system, software application, and/or end-user device 210, and the like.

The end-user device 210 can be a computing device capable of network 260 communications including, but not limited to, a mobile device, a smartphone, a laptop computer, a desktop computer, a tablet computer, a notebook computer, and the like. The end-user device 210 can be required to include or be connected to one or more biometric sensors 220 appropriate for capturing the user's 205 hand image 225. Examples of such biometric sensors 220 can include, but are not limited to, a digital camera, an infrared sensor, and the like. The end-user device 210 can also include any required processing software required by the biometric sensors 220 (i.e., for converting or translating the raw data for consumption).

The biometric security client 215 can be a software application that provides the user 205 with the means to interact with the biometric security system 230 for the purpose of biometric authentication. The biometric security client 215 can provide the biometric security service described in Method 100 and these terms can be used interchangeably as used herein.

The hand image 225 can be a digital image of one of the user's 205 hands; the hand imaged should correspond to the hand used to register with the biometric security system 230. In the hand image 225, the user's 205 hand can have its palm facing the camera 220 as well as appropriate oriented to any other biometric sensors 220. The hand image 225 can be required to include the entire length of the user's 205 hand—from the palm heel to the tip of the longest finger. The thumb can be excluded from the hand image 225 as its natural orientation in this position is unsuitable for identification purposes.

The biometric security system 230 can be a computer system configured to verify the user's 205 identity via the hand image 225 against a biometric reference library 240 of registered users 205. The biometric security system 230 can be used as the authenticating authority for access control to the secure element and can utilize the Biometric Open Protocol Standard (BOPS) as maintained by the Institute of Electrical and Electronics Engineers (IEEE) like IEEE2410. Additionally, the biometric security system 230 can be connected to a secondary electronic or computing device or another computer system that provides the user with access to the secure element.

In a physical security example, the biometric security system 230 can be connected to electronic door locks that it opens upon successful biometric authentication of the user 205. As a computer-related example, the biometric security system 230 can be connected via the network 260 to a large data storage system and the biometric security system 230 can enforce access restrictions to specific data via biometric authentication.

The biometric reference library 240 can be maintained in a data store 235 that is accessible by the biometric security system 230. The biometric reference library 240 can represent the biometric data that defines each user's 205 biometric identity when registering with the biometric security system 230. Each library 240 record can be comprised of palm section data 245 and fingertip aggregate data 250.

Palm section data 245 can represent the biometric data extracted from or highlighted within the palmar area of the user's 205 hand image 225. Likewise, the fingertip aggregate data 250 can be the biometric data extracted from or highlighted within a fingertip aggregate section area of the user's 205 hand image 225. The fingertip aggregate section can be a section of the hand image 225 comprised of the contiguous fingertip areas of the four fingers; the fingertip aggregate section can be expanded to handle cases of polydactyly. These areas can be graphically presented in more detail in subsequent Figures.

As is well known in the Art, searching large quantities of data can be resource and time consuming, especially when coupled with the image processing overhead required for characteristic (e.g., minutiae) identification and comparison.

Thus, the present invention can teach an approach that utilizes the palm section of the hand image 225 to filter the biometric reference library 240 prior to processing fingerprint data. Many existing approaches can capture the user's 205 hand image 225 only to focus on the fingertips for fingerprint identification, which wastes resources handling (e.g., sending, capturing, processing, etc.) data (i.e., the rest of the hand image 225) that is not used.

The present invention can be used to reduce processing time and, therefore, resource consumption of the verification process. Upon receiving the user's 205 hand image 225, the biometric security system 230 can be configured to compare the palm section of the hand image 225 against the palm section data 245 of the biometric reference library 240, resulting in a smaller subset of records for fingertip analysis.

Records in the resultant subset can have verification scores that meet a predetermined verification threshold (i.e., the palm section of the hand image 225 must be quantitatively within tolerance to the reference palm section data 245). The verification score can be calculated in accordance with a preset formula to quantify the similarity between the hand image 225 and the corresponding reference data 245 and 250.

The verification threshold can represent the minimum value for the verification scores. The verification threshold can be a predefined value in the biometric security system 230. It can be a static value or can be dynamically-generated based upon current operating conditions, the operation being performed, and/or the privileges of the user 205. It can also have a limited level of user-configurability (e.g., the user 205 can only increase, not decrease, the value).

While using the palm section is, at most, an all record search, the criteria can be broader and require a less intensive comparison than fingerprints. For example, the size and shape of the palm section can reduce the number of biometric reference library 240 records for fingertip analysis to ten percent or less, negating the need to perform this resource-consuming process on ninety percent of the records.

Further, characteristics of the palm section can be kept as data values that do not require image comparison. For example, palm width can be measured and stored as a numeric value instead of performing the more resource-consuming task of image comparison. As such, image-related data can be used as sequential filters to further reduce the quantity of biometric reference library 240 records requiring image comparison of palm section data 245.

As an example, the palm width from the hand image 225 can be three and a half inches. The biometric reference library 240 can be queried for those records having a palm width value between three and three eighths inch and three and five eighths inch; a tolerance around the value from the hand image 225 can help to account for image variances due to user operation, natural body fluctuations, and/or injury. This query can reduce the number of records that require further examination by sixty percent. The remaining forty percent of the records can then be queried based on palm color, resulting in a subset that is thirty percent of the original amount. This subset can then be processed by comparing palm shape and palmar minutiae to calculate the verification score for each. Only those records meeting the verification threshold can proceed to fingertip analysis.

In another contemplated embodiment, the palm section data 245 can also include general hand data to allow the entirety of the hand image 225 to be compared to a reference standard image. Hand-to-hand comparison can provide similar value by eliminating records based on general hand shape. However, this can also be problematic as hand shape is easily influenced by daily tasks and injury.

Once the biometric security system 230 has filtered the biometric reference library 240 to a smaller subset of records, the fingertip aggregate section can be identified in the hand image 225, processed, and compared to the fingertip aggregate data 250 of the subset records. A verification score can be generated for each comparison.

Ideally, the fingertip aggregate data 250 of a single library record 240 can 100%match the hand image 225. However, artefacts or imperfections due to environmental conditions or the end-user device 210 can affect the quality of the hand image 225 and its processing, resulting in no match (a false negative). Additionally, exact matching (100%) can be unobtainable in practice due to uncontrollable conditions (e.g., hardware problems, normal body changes, lighting, etc.).

Therefore, a second verification threshold can be used for the verification scores of the fingertip aggregate data 250, which should result in a single, most likely match. When multiple library 240 records meet the second verification threshold, additional measures can be taken to determine a single match. The biometric security system 230 can return an authentication message 255 with the results (success or failure) of the biometric authentication to the end-user device 210. Depending upon the specific implementation, the authentication message 255 can trigger additional actions on the part of the end-user device 210.

In another contemplated embodiment, the functionality of this biometrics-processing approach can be expanded to accommodate authentication of the user 205 against their own biometric reference data, as described in Method 100. In such an embodiment, the biometric reference library 240 can be reduced to a single record—the user's 205 reference data. While resource savings due to the reduction of the number of records processed is not possible, the present invention can be save resources by allowing the verification score of the palm section of the hand image 225 to satisfy the biometric authentication process for low security operations.

As used herein, presented data store 235 can be a physical or virtual storage space configured to store digital information. Data store 235 can be physically implemented within any type of hardware including, but not limited to, a magnetic disk, an optical disk, a semiconductor memory, a digitally encoded plastic memory, a holographic memory, or any other recording medium. Data store 235 can be a stand-alone storage unit as well as a storage unit formed from a plurality of physical devices. Additionally, information can be stored within data store 235 in a variety of manners. For example, information can be stored within a database structure or can be stored within one or more files of a file storage system, where each file may or may not be indexed for information searching purposes. Further, data store 235 can utilize one or more encryption mechanisms to protect stored information from unauthorized access.

Network 260 can include any hardware/software/and firmware necessary to convey data encoded within carrier waves. Data can be contained within analog or digital signals and conveyed though data or voice channels. Network 260 can include local components and data pathways necessary for communications to be exchanged among computing device components and between integrated device components and peripheral devices. Network 260 can also include network equipment, such as routers, data lines, hubs, and intermediary servers which together form a data network, such as the Internet. Network 260 can also include circuit-based communication components and mobile communication components, such as telephony switches, modems, cellular communication towers, and the like. Network 260 can include line based and/or wireless communication pathways.

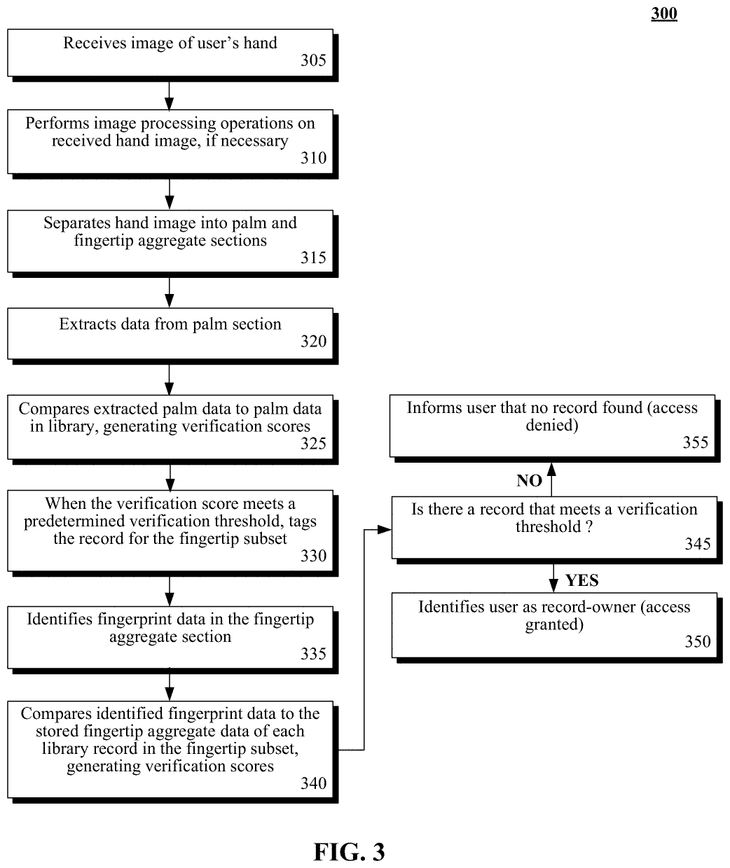

FIG. 3 is a flowchart of a method 300 detailing the use of palmar data as a filter for a biometric reference library in accordance with embodiments of the inventive arrangements disclosed herein. Method 300 can be performed within the context of method 100 and/or system 200.

Method 300 can begin in step 305 where the biometric security service receives the image of the user's hand. If necessary, image processing operations can be performed on the received hand image in step 310. The image processing operations performed should normalize the received hand image with the reference data for consistent and accurate comparison.

In step 315, the hand image can be separated in palm and fingertip aggregate sections. The necessary data can be extracted from the palm section in step 320. Data extracted from the palm section can include, but is not limited to, dimensions, color, shape, friction ridge

In step 325, the extracted palm data can be compared to the palm data in the biometric reference library. Step 325 can include the generation of a verification score for each library record.

When the verification score meets a predetermined verification threshold, the record can be tagged to be in the subset of records for fingertip processing in step 330. In step 335, fingerprint data can be identified in the fingertip aggregate section of the received hand image. The identified fingerprint data can be compared to the stored fingertip aggregate data of each library record in the fingertip subset in step 340. Step 340 can also include the generation of verification scores for each compared library record.

In step 345, it can be determined if there is a record in the fingertip subset whose verification score meets the verification threshold. When no record of the subset meets the verification threshold, the user can be informed that no record was found in step 355. Step 355 can indicate a biometric authentication failure on the part of the user and access to the secured element can be denied to the user.

When a record of the subset meets the verification threshold, step 350 can be performed where the user is identified as the record-owner and the biometric authentication is successful. Step 350 can grant the user access to the secure element.

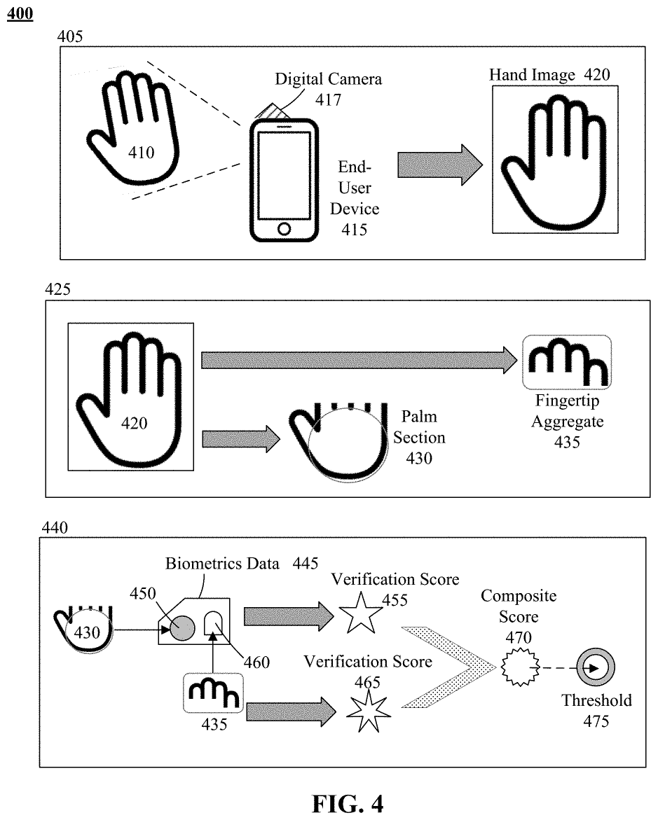

FIG. 4 is a collection 400 of illustrations 405, 425, and 440 that graphically depict an example use of palmar and fingertip biometrics for biometric authentication in accordance with embodiments of the inventive arrangements disclosed herein. The biometric authentication process shown in collection 400 can be performed within the context of method 100 and/or system 200.

Illustration 405 can represent the use of the end-user device 415 to capture the user's hand image 420. The user can position their hand 410 within the field of view of the digital camera 417 and capture the image via the user interface that supports operation of the digital camera 417 or the user interface of the biometric security client having an embedded digital camera 417 component.

In this example, the digital camera 417 can be located on the back-side of the end-user device 415, often referred to as “rear-facing”. However, other positions of the digital camera 417 within the end-user device 415 can be considered without departing from the spirit of the present invention.

The user interface used with the digital camera 417 can be configured to include indicators to assist the user in capturing the entirety of their hand 410. Such a user interface can be an extension of the biometric security service or can be an auxiliary software application available to the user. Additionally, this user interface and/or the biometric security service can require and/or enforce the use of a specific hand 410. That is, the user can be required to capture a hand image 420 of only their right hand 410 for verification; a hand image 420 of the user's left hand 610 can be automatically rejected.

Illustration 425 can present the segregation of the hand image 420 into a palm section 430 and a fingertip aggregate section 435. The palm section 430 can conform to generally-accepted medical definition as the inner area of the hand starting from the wrist to the root of the fingers.

The fingertip aggregate section 435 can be a section of the hand image 420 that includes the area of each finger from the distal inter-phalangeal joint (the furthest joint) to the ending tip, as this is the area that contain one's fingerprints. These areas can be collected as a contiguous set.

Illustration 440 can represent the processing of the user's hand image 420 against their personal biometrics data 445. The user's palm section 430 can be compared to the palm section data 450 of their biometrics data 445. This comparison can generate a corresponding verification score 455. The user's fingertip aggregate section 435 can then be compared to the fingertip aggregate data 460, generating another corresponding verification score 465.

In this example, both verification scores 455 and 465 can be combined in accordance with a predefined algorithm to produce a composite score 470. The composite score 470 can then be compared to the verification threshold 475 to determine success/failure.

Combining the verification scores 455 and 465 for the palm section 430 and fingertip aggregate section 435 can synthesize the similarity of both sections 430 and 435 into a single value for comparison to a single verification threshold 475. This approach can be used as the primary means of evaluation, to delineate between multiple matches, or to reassess a failure after a success.

As a means of reassessment can be used in an implementation where the palm section 430 and fingertip aggregate section 435 have separate verification thresholds. Reassessment can be required when the palm section 430 is evaluated and meets its verification threshold, but the fingertip aggregate section 435 fails to meet its verification threshold, such as due to swelling from an injury. In this situation, combining the verification scores 455 and 465 can help balance the localized hand change or any other image imperfections. As this is for security, only a minor variance can be tolerated without indicating failure.

The diagrams in the Figures illustrate the architecture, functionality, and operation of possible implementations of systems and methods according to various embodiments of the present invention. It will also be noted that each block of the block diagrams and combinations of blocks in the block diagrams can be implemented by special purpose hardware-based systems that perform the specified functions or acts, or combinations of special purpose hardware and computer instructions.

What is claimed is:

1. A method for authenticating hand biometrics comprising:
receiving of a digital image of a hand belonging to a user by a biometric security system, wherein the hand is presented palm-up and includes a full-length view of at least four fingers excluding a thumb;
identifying, within the received image, a palm section of the hand and a fingertip aggregate section, wherein the fingertip aggregate section comprises contiguous fingertip areas of each finger;
preparing the identified palm section for comparison to at least one reference palm section maintained by the biometric security system, wherein said at least one reference palm section is established during user registration with the biometric security system;
generating a first verification score for each reference palm section, wherein the first verification score quantifies a likeness between the prepared palm section and a reference palm section;
when the first verification score fails to meet a first predetermined verification threshold, terminating said biometric authentication process, wherein indication of a failed authentication is provided to the user and at least one computer system that the biometric security system safeguards, wherein resources required to process the user's fingertip aggregate section are conserved;
when at least one reference palm section meets the first predetermined verification threshold, preparing the identified fingertip aggregate section for comparison to at least one reference fingertip aggregate section respective to the at least one palm section, wherein the at least one respective reference fingertip aggregate section is established during user registration with the biometric security system;
generating a second verification score for each reference fingertip aggregate section, wherein the second verification score quantifies a likeness between the prepared fingertip aggregate section and a reference fingertip aggregate section, wherein said generation is performed on a quantity of reference fingertip aggregate sections equal to or less than a total number of reference fingertip aggregate sections maintained by the biometric security system, wherein an overall amount of resources spent processing reference fingertip aggregate sections is decreased by at least twenty percent as compared to an amount of resources spent processing all reference fingertip aggregate sections; and
when the second verification score meets a second predetermined verification threshold, indicating a successful biometric authentication to the user and at least one computer system that the biometric security system safeguards.

2. The method of claim 1, wherein preparing the identified palm section further comprises:
performing at least one image processing operation upon the identified palm section to normalize a format of the identified palm section to the format of the at least one reference palm section;
marking dimensions of the palm section; and
identifying, within the palm section, a set of palmar features, wherein said minutiae are accepted as standards for palm print identification.

3. The method of claim 2, wherein generating the first verification score further comprises:
comparing the marked dimensions of the palm section to the marked dimensions of the reference palm section;
computing a difference between the marked dimensions;
comparing the identified set of palmar features with the reference palm section's set of palmar features;
computing at least one of a difference between the sets of palmar features and a quantity of matching features; and
calculating the first verification score according to a predefined algorithm using the computed marked dimensions difference and the at least one of the palmar features differences and the quantity of matching features.

4. The method of claim 1, wherein preparing the identified fingertip aggregate section further comprises:
performing at least one image processing operation upon the identified fingertip aggregate section to normalize a format of the identified fingertip aggregate section to the format of the at least one reference fingertip aggregate section; and
identifying, in each fingertip area of the fingertip aggregate section, a set of fingerprint minutiae, wherein said minutiae are accepted as standards for fingerprint identification.

5. The method of claim 4, wherein generating the second verification score further comprises:
comparing the identified set of fingerprint minutiae with the reference fingertip aggregate section's set of fingerprint minutiae;
computing at least one of a difference between the sets of fingerprint minutiae and a quantity of matching minutiae; and
calculating the second verification score according to a predefined algorithm using the computed at least of the difference between fingerprint minutiae sets and the quantity of matching minutiae.

6. The method of claim 1, wherein the biometric security system utilizes a Biometric Open Protocol Standard (BOPS) as maintained by Institute of Electrical and Electronics Engineers (IEEE).

7. The method of claim 1, further comprising:
when the second verification score fails to meet the second predetermined verification threshold, combining the first and second verification scores into a composite verification score in accordance with a predefined formula;
comparing the composite verification score to a third predetermined verification threshold;
when the composite verification score meets the third predetermined verification threshold, indicating the successful biometric authentication to the user and at least one computer system that the biometric security system safeguards; and
when the composite verification score fails to meet the third predetermined verification threshold, terminating said biometric authentication process, wherein indication of a failed authentication is provided to the user and at least one computer system that the biometric security system safeguards.

8. The method of claim 7, wherein the third predetermined verification threshold is a most-restrictive value as selected from the first and second predetermined verification thresholds.

9. The method of claim 1, wherein the first and second predetermined verification thresholds are dynamic values that are at least one of calculated based upon a set of current operating parameters and a privilege level of the user and selected from a predefined list of values associated with available operations, wherein a value of the first and second predetermined verification thresholds changes based upon an operation being performed by the user.

10. A method for device-based processing of hand biometrics comprising:
receiving of a user-selection of an operation for execution by a biometric security service running on a resource-constrained end-user device, wherein said operation requires successful biometric authentication of a user to be executed;
dynamically ascertaining a threshold value for the user-selected operation, wherein said threshold value indicates a stringency of the biometric authentication for said user-selected operation, wherein said threshold value is at least one of calculated based upon a set of current operating parameters and a privilege level of the user and selected from a predefined list of values associated with available operations;
receiving a digital image of the user's hand for the biometric authentication, wherein the hand is presented palm-up and includes a full-length view of at least four fingers excluding a thumb;
identifying, within the received image, a palm section of the hand and a fingertip aggregate section, wherein the fingertip aggregate section comprises contiguous fingertip areas of each finger;
preparing the identified palm section for comparison to a reference palm section for the user, wherein said reference palm section is established during user registration with the biometric security service;
generating a first verification score for the reference palm section, wherein the first verification score quantifies a likeness between the prepared palm section and the reference palm section;
when the first verification score fails to meet a first predetermined verification threshold, terminating biometric authentication, wherein indication of a failed authentication is provided to the user and execution of the user-selected operation is prohibited, wherein it is assumed that a successful authentication of the fingertip aggregate section after the failure of the palm section is untrustworthy, wherein end-user device resources required to process the fingertip aggregate section are conserved by said termination;
when the reference palm section meets the first predetermined verification threshold, preparing the identified fingertip aggregate section for comparison to a reference fingertip aggregate section, wherein the reference fingertip aggregate section is established during user registration with the biometric security service;
generating a second verification score for the reference fingertip aggregate section, wherein the second verification score quantifies a likeness between the prepared fingertip aggregate section and the reference fingertip aggregate section; and
when the second verification score meets a second predetermined verification threshold, indicating a successful biometric authentication to the user and the execution of the user-selected operation is allowed.

11. The method of claim 10, further comprising:
when the second verification score fails to meet the second predetermined verification threshold, combining the first and second verification scores into a composite verification score in accordance with a predefined formula;
comparing the composite verification score to a third predetermined verification threshold;
when the composite verification score meets the third predetermined verification threshold, indicating the successful biometric authentication to the user and the execution of the user-selected operation is allowed; and
when the composite verification score fails to meet the third predetermined verification threshold, terminating biometric authentication, wherein indication of a failed authentication is provided to the user and the execution of the user-selected operation is prohibited.

12. The method of claim 11, wherein the third predetermined verification threshold is a most-restrictive value as selected from the first and second predetermined verification thresholds.

13. The method of claim 11, wherein the third predetermined verification threshold is a third value, different and independent from the first and second predetermined verification thresholds.

14. The method of claim 10, wherein the biometric security service utilizes a Biometric Open Protocol Standard (BOPS) as maintained by Institute of Electrical and Electronics Engineers (IEEE).

15. A computer program product comprising a computer readable storage medium having computer usable program code embodied therewith, the computer usable program code comprising:
computer usable program code configured to receive a digital image of a hand belonging to a user, wherein the hand is presented palm-up and includes a full-length view of at least four fingers excluding a thumb;
computer usable program code configured to identify, within the received image, a palm section of the hand and a fingertip aggregate section, wherein the fingertip aggregate section comprises contiguous fingertip areas of each finger;
computer usable program code configured to prepare the identified palm section for comparison to at least one reference palm section, wherein said at least one reference palm section is established during user registration;
computer usable program code configured to generate a first verification score for each reference palm section, wherein the first verification score quantifies a likeness between the prepared palm section and a reference palm section;
computer usable program code configured to, when the first verification score fails to meet a first predetermined verification threshold, terminate said biometric authentication process, wherein indication of a failed authentication is provided to the user and at least one computing system, wherein resources required to process the user's fingertip aggregate section are conserved;
computer usable program code configured to, when at least one reference palm section meets the first predetermined verification threshold, prepare the identified fingertip aggregate section for comparison to at least one reference fingertip aggregate section respective to the at least one palm section, wherein the at least one respective reference fingertip aggregate section is established during user registration;
computer usable program code configured to generate a second verification score for each reference fingertip aggregate section, wherein the second verification score quantifies a likeness between the prepared fingertip aggregate section and a reference fingertip aggregate section, wherein said generation is performed on a quantity of reference fingertip aggregate sections equal to or less than a total number of reference fingertip aggregate sections, wherein an overall amount of resources spent processing reference fingertip aggregate sections is decreased by at least twenty percent as compared to an amount of resources spent processing all reference fingertip aggregate sections; and
computer usable program code configured to, when the second verification score meets a second predetermined verification threshold, indicate a successful biometric authentication to the user and at least one computing system.

16. The computer program product of claim 15, further comprising:
computer usable program code configured to, when the second verification score fails to meet the second predetermined verification threshold, combine the first and second verification scores into a composite verification score in accordance with a predefined formula;
computer usable program code configured to compare the composite verification score to a third predetermined verification threshold;
computer usable program code configured to, when the composite verification score meets the third predetermined verification threshold, indicate the successful biometric authentication to the user and at least one computer system; and
computer usable program code configured to, when the composite verification score fails to meet the third predetermined verification threshold, terminate said biometric authentication process, wherein indication of a failed authentication is provided to the user and at least one computer system.

17. The computer program product of claim 15, wherein preparing the identified palm section further comprises:
computer usable program code configured to perform at least one image processing operation upon the identified palm section to normalize a format of the identified palm section to the format of the at least one reference palm section;
computer usable program code configured to mark dimensions of the palm section; and
computer usable program code configured to identify, within the palm section, a set of palmar features, wherein said features are accepted as standards for palm print identification.

18. The computer program product of claim 17, wherein generating the first verification score further comprises:
computer usable program code configured to compare the marked dimensions of the palm section to the marked dimensions of the reference palm section;
computer usable program code configured to compute a difference between the marked dimensions;
computer usable program code configured to compare the identified set of palmar features with the reference palm section's set of palmar features;
computer usable program code configured to compute at least one of a difference between the sets of palmar features and a quantity of matching features; and
computer usable program code configured to calculate the first verification score according to a predefined algorithm using the computed marked dimensions difference and the at least one of the palmar features differences and the quantity of matching features.

19. The computer program product of claim 15, wherein preparing the identified fingertip aggregate section further comprises:
computer usable program code configured to perform at least one image processing operation upon the identified fingertip aggregate section to normalize a format of the identified fingertip aggregate section to the format of the at least one reference fingertip aggregate section; and
computer usable program code configured to identify, in each fingertip area of the fingertip aggregate section, a set of fingerprint minutiae, wherein said minutiae are accepted as standards for fingerprint identification.

20. The computer program product of claim 19, wherein generating the second verification score further comprises:
computer usable program code configured to compare the identified set of fingerprint minutiae with the reference fingertip aggregate section's set of fingerprint minutiae;
computer usable program code configured to compute at least one of a difference between the sets of fingerprint minutiae and a quantity of matching minutiae; and
computer usable program code configured to calculate the second verification score according to a predefined algorithm using the computed at least of the difference between fingerprint minutiae sets and the quantity of matching minutiae.
